(19) United States
(12) Patent Application Publication
(10) Pub. No.: US 2007/0136252 A1
(43) Pub. Date: Jun. 14, 2007

(54) SYSTEMS AND METHODS FOR CENTRALIZED PUBLISHER TAGGED DATA SALES LISTINGS

(75) Inventors: Keith W. Teare, Palo Alto, CA (US); Matt Kaufman, Redwood City, CA (US); Vidar Hokstad, London (GB)

Correspondence Address: GREENBERG TRAURIG LLP, 2450 COLORADO AVENUE, SUITE 400E, SANTA MONICA, CA, 90404, US

(73) Assignee: EDGEIO CORPORATION

(21) Appl. No.: 11/548,625

(22) Filed: Oct. 11, 2006

Related U.S. Application Data
(60) Provisional application No. 60/596,688, filed on Oct. 12, 2005.

(51) Int. Cl. G06F 17/30

(52) U.S. Cl. 707/3

(57) ABSTRACT

A novel listing republication system and methods are provided for republication of sales listings from websites with syndication feed websites of commercial retailers. Users mark websites with syndication feed entries for republication using a unique tag keyword. Other tags of the website with a syndication feed or taxonomy-like hierarchical organization of commercial retailers are used to index each republished listing to make it searchable. The system automatically monitors the original listings for changes periodically using a syndication feed analyzer or a ping-server. A geographical identification system is used to allow users to search based on geography.

### RELATED APPLICATION

This application claims the benefit of and Paris Convention priority of U.S. Provisional Application Ser. No. 60/596,688, filed Oct. 12, 2005, the contents of which are incorporated by reference herein in their entirety.

### BACKGROUND

The present disclosure relates generally to centralization of disparate data sets, particularly in the context of sales listings using ping-servers, syndication feeds, and application programming interfaces (API) to retrieve and index sales listings and to make those listings searchable or available by republication in a central location.

### SUMMARY

A novel listing republication system and methods are provided for republication of sales listings from websites with syndication feed websites of commercial retailers. Users mark websites with syndication feed entries for republication using a unique tag keyword. Other tags of the website with a syndication feed or taxonomy-like hierarchical organization of commercial retailers are used to index each republished listing to make it searchable. Periodically, the system automatically monitors the original listings for changes using a syndication feed analyzer or a ping-server. A geographical identification system is used to allow users to search based on geography.

According to a feature of the present disclosure, there is provided a system comprising: a ping-server monitor to monitor listings from websites with syndication feeds, a syndication feed analyzer for monitoring syndication feeds of the listings from the websites with syndication feeds, a unit to detect the presence of at least one tag keyword in the listings, and a unit to store at least one listing having the at least one tag keyword and make available the listing for republication.

According to a feature of the present disclosure, there is also disclosed a method comprising: providing a tag keyword, providing a ping-server monitoring unit to monitor at least one ping-server for listings having at least one tag keyword, and providing a republication unit to republish the listings having the at least one tag keyword as republished listings.

Finally, according to a feature of the present disclosure, a machine-readable medium having program instructions stored thereon executable by a processing unit for performing the steps of monitoring at least one ping-server for listings having at least one tag keyword and republishing the listings having at least one tag keyword as republished listings.

### DRAWINGS

The above-mentioned features and objects of the present disclosure will become more apparent with reference to the following description taken in conjunction with the accompanying drawings wherein like reference numerals denote like elements and in which:

FIG. 1 is block diagram of an embodiment of the system of the present disclosure.

FIG. 2 is a flow chart of an embodiment of a method of using the system of the present disclosure.

FIG. 3 is a block diagram of an embodiment of a geographical hierarchy.

### DETAILED DESCRIPTION

As used in the present disclosure, “syndication feed” shall be defined as data made available on the internet to be consumed or distributed by users or services different from the originating user or service. Examples of syndicated feed include really simple syndication (RSS) feeds, ATOM feeds, and XML feeds.

As used in the present disclosure, “website with syndication feed” shall be defined to include any website having a syndication feed. The term “weblog” shall be understood to be a subset of websites with syndication feeds and will likewise be periodically used herein as representative of the entire class of websites with syndication feeds.

Networks are decentralized organizations of computers and devices. The internet, naturally, is also a collection of decentralized computers and devices. People surf the internet, bringing the content of websites into their homes as if each individual website were a neighborhood library or marketplace. Indeed, use of the internet is the ultimate convenience in terms of the ability to participate in the exchange of information or in commerce from the comfort of our own homes. Despite this perception among users, the internet continues to be a web of decentralized computers and devices spanning the globe.

Given the decentralized nature of the internet, many companies and individuals have attempted to centralize internet content. Indeed, search engines, shopping bots, and the like are all attempts to collect, index, and make available the vast trove of content on the internet at centralized “hubs.” Generally, this process involves finding webpages and indexing their content based on the content itself or meta-data embedded in the webpage. In the case of search engines, these attempts are widely successful. Other attempts, such as indexing and providing centralized shopping sites, however, have met with much more limited success in terms of their attempts to centralize shopping listings generally. In fact, visitors to many of these types of sites never get past the listings provided by preferred commercial vendors that pay to have their listings seen. Consequently, true centralization in these types of sites is lacking.

Moreover, small volume sellers or infrequent sellers have little success in having internet listings disseminated widely via the internet for lack of recognition by websites that centralize listings having offers for sale. Small volume sellers and sellers who sell infrequently must rely on websites, such as eBay, that charge hefty premiums to list items and hefty premiums to have buyers pay for the items. Consequently, the most successful commercial sellers are those that work hard to maintain their visibility on the internet.

From a consumer's standpoint, these inefficiencies fail to maximize competition and other potential advantages of online marketplaces. Online retailers reduce their costs by dispensing with storefronts, as well as centralizing and streamlining merchandise inventories and shipping processes. These models reduce ancillary costs that are ordinarily passed on to consumers by eliminating middlemen, shipping costs to get goods to their final destinations, rent and salaries for store fronts and store front employees, etc. Failure to maximize competition in the internet marketplace, however, reduces the percentage of these advantages to online retailers that are passed on to the consumer.

Likewise, online shopping often prevents consumers from making live contact with sellers. Buyers are not able to see and handle the merchandize before they buy. Additionally, consumers are often deprived of selecting merchants that are geographically near to them, which increases actual shipping costs, freight times, and prevents in-person exchanges.

The present inventor has discovered “a system” or “systems” and methods for centralizing the internet marketplace, while allowing and encouraging small merchants or infrequent merchants to list goods and services of their own and still make them visible and searchable in a centralized location. These advantages encourage competition in the marketplace, satisfy niche goods and services that would otherwise be unavailable online, and provide a more cost-reasonable venue for all sellers rather than only the large commercial retailers.

The system and methods of the present invention make use of the tagging systems of websites in conjunction with ping-servers and syndication feeds. For example, a weblog engine provides users with a space to enter text and upload files, such as images. Once the text is entered and files are uploaded, the weblog engine formats and publishes the content as webpages that may be read by web browsers. Consequently, users need know nothing more than how to type to use their weblog to post entries. Similarly, other websites may have specifically written syndication feeds without an automated engine for posting tagged listings.

Nevertheless, during the initial evolution of websites with syndication feeds, users discovered that their content was not easily searchable by most search engines because individual pages lacked the meta-data of traditional webpages. Additionally, users updated websites with syndication feeds with new listings erratically and infrequently. To address these issues, ping-servers were developed. Ping-servers are notified each time a listing in a weblog is created and posted. They essentially provide lists of recently updated websites with syndication feeds. Thus, for the small user, ping-servers provide the infrastructure to mobilize their content more readily.

In addition to contacting ping-servers when a new website with syndication feed listing is posted, websites with syndication feeds often have subsystems to produce syndication feeds. Syndication feeds provide a way by which users may be updated in almost real-time of updates to their favorite websites with syndication feed and websites with syndication feeds. Syndication feeds conform to generally accepted standards and may include data indicating the time of the post and content of the post. Thus, once a website is monitoring a particular feed, it will automatically become aware of new listings and changes to the listing due to the data contained in the syndication feed. For a republication engine, an syndication feed provides a simple mechanism to monitor listings for changes and re-republishes them when the syndication feed indicates a modification. Alternately, re-republication occurs when a ping-server indicates the listing is modified. These may be used in combination with each other; a person of ordinary skill in the art will known and understand both the implementation, as well as relevant criteria in decided which of these to implement and how to implement them.

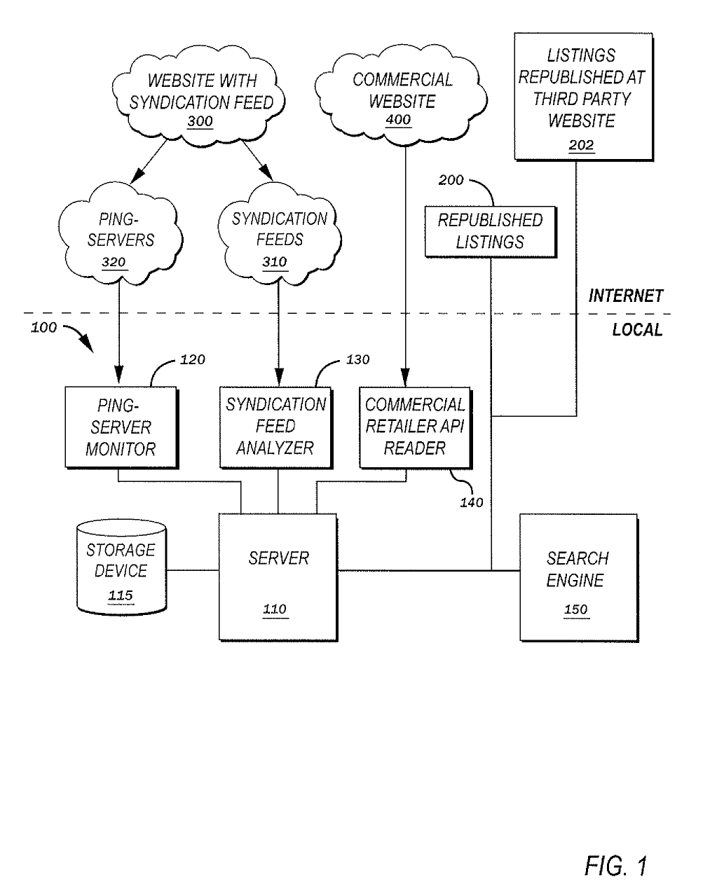

Turning now to FIG. 1, there is shown an embodiment of a system of the present disclosure. Listing republication system 100 is shown. It comprises a set of local components including server 110, storage device 115, ping-server monitor 120, syndication feed analyzer 130, commercial retailer application programming interface (API) reader 140, and search engine 150. Listing republication system 100 republishes internet listings as republished listings 200 from website with syndication feeds 300 and commercial websites 400. Moreover, republished listings 200 may be republished as part of the present system or on third party websites 202. Artisans will understand that the disclosed embodiment is exemplary only, and that any number of combinations may be deployed to accomplish the same functionality and objectives.

Generally, server 110 comprises a web server and any related servers deemed necessary to provide sufficient bandwidth, processing power, storage, and other functions such as DNS resolution, routing, etc., as would be known and understood by a person of ordinary skill in the art. Server 110 provides a backbone upon which the other components of listing republication system too depend. Storage device 115 may be connected to server 110. Storage device 115 may comprise hard disk drives, tapes, portable storage solutions, or other storage devices and solutions known to artisans. According to an embodiment, storage device may also comprise a database, such as a SQL or ORACLE database. For example, multiple SQL databases may be used, each of which stores all or a part of the total data set. These may then be combined with multiple full text indexing engines and remote backup systems. The actual hardware storage mechanism in these types of cases will be controlled by the database implementation.

Ping-server monitor 120 and syndication feed analyzer 130 connect to server 110. According to an embodiment, ping-server monitor 120 and syndication feed analyzer 130 may be software modules installed on server 110. Alternately, these software modules may be installed on dedicated terminals connecting to server 110 by wired or wireless networking connections, as would be known and understood by a person of ordinary skill in the art. According to still other embodiments, ping-server monitor 120 and syndication feed analyzer 130 may be hardware solutions dedicated to their respective tasks.

Ping-server monitor 120 monitors one or more ping-servers 320. As listings, such as websites with syndication feed listings, are created and posted, website with syndication feed's 300 software may be configured to notify one or more ping-servers 320 of the new listing automatically. Ping-server monitor 120 tracks the new listings on ping-servers 320. Listings cited by ping-server are crawled and the content stored and indexed with the title of the listing, the time that the listing was published, the listing's text, the listing's tags, and, if applicable, the GUID, according to an embodiment. The actual method by which listing content is obtained will be known and understood by a person of ordinary skill in the art. Generally, listing republication system 100 will be configured to monitor as many ping-servers 320 as feasible to ensure that the system is notified of new listings comprehensively.

However, embodiments of the present disclosure may be implemented such that only a small number of ping-servers 320 are monitored. For example, a dedicated ping-server 320 may be included as part of listing republication system 100. According to this type of embodiment, ping-server 320 is directly connected to server 110. Direct communication of ping-server 320 may therefore dispense with the need for ping-server monitor 120 according to these embodiments. Users who post listings that they desire to be aggregated using listing republication system 100 will then be instructed to configure their website with syndication feed's 300 software to include connected ping-server 320.

Syndication feed analyzer 130 is provided to continue to monitor listings once they are republished for modifications to the original listing. Syndication feed analyzer 130 reads syndication feeds 310 that are provided by the website with syndication feed 300 software, if configured to do so. Syndication feeds 310 may contain relevant data, such as the date of publication of each listing, which allows syndication feed analyzer 130 to determine when changes are made to each listing. When changes are detected to the listings, server 110 effects re-republication of the listing with the updated data. According to embodiments, syndication feeds 310 may be read with syndication feed analyzer 130 at set intervals, every six hours for example, for the purposes of efficiency. According to an embodiment, syndication feed analyzer 130 will, in addition to simply reading syndication feeds 310, download the feed, process the feed for specific data elements, which are passed to server 110. Server 110 then acts on the passed data elements as presented herein. Artisans will known and understand how to implement syndication feed analyzer 130 to maintain such efficiency, including the timing of checking syndication feeds 310.

According to embodiments, syndication feed analyzer 130 may a serve a redundant function to ping-server monitor 120. Ping-server monitor 120 monitors ping-servers 320 in real-time. Thus, as websites with syndication feed listings 302 are updated, ping-servers 320 are apprised of the change in real-time and the modified listing is queued to be crawled and recaptured for re-republication by ping-server monitor 120. However, depending on the number of the queue items to be crawled, syndication feed analyzer 130 may update republication listing and make the republished listings current before the original listing is crawled.

According to an embodiment, for example, a website with syndication feed 300 lists an original listing. Website with syndication feed 300 notifies ping-servers 320. Ping-server monitor 120 causes listing republication system 100 to republish the listing as described herein. Thereafter, the original listing is updated on the website with syndication feed 300. Ping-servers 320 are again notified of the updated listing, which causes ping-server monitor 120 to queue the updated listing to be crawled and the updated listing retrieved for re-republication. However, before the updated listing is crawled, syndication feed analyzer 130 reads both the original listing and the updated listing, causing updated listing to be republished in place of the original listing. Thereafter, server 110 removes the updated listing from the queue of listings notified from ping-server monitor to be crawled. Efficient implementation of the interaction between ping-server monitor 120 and syndication feed analyzer 130 will be readily apparent to a person of ordinary skill in the art.

A feature that may be included with syndication feed analyzer 130 is a listing update scheduler. Certain types of websites with syndication feeds 300 are not designed to notify ping-servers 320 of listings, but may still have syndication feeds 310. For example, website with syndication feeds 300 may be a real estate website that is not configured to notify ping-server 320 of listings. In order to monitor these types of websites with syndication feeds 300, listing update scheduler may be configured to read syndication feeds 310 on a regular basis. Thus, for these types of websites with syndication feeds 300, registration with listing republication system 100 will cause listings on these sites to be regularly republished or updated. Naturally, the listing update scheduler applies to any website with syndication feeds 300 that is not configured to utilize ping-servers 320 or fails to notify ping-server 320 when new listings are included.

Commercial website API reader 140 of listing republication system 100 may also be configured to interact with commercial internet vendor's API to pull the commercial retailers listings as well, according to embodiments. Artisans will appreciate that the implementation of such features will vary based on the APIs from commercial vendor to commercial vendor. Both the listings of commercial websites 400, as well as auction sites may be obtained in this way.

Once listings are “pulled” for republishing from website with syndication feeds 300 and commercial websites 400, server 110 indexes the listings and republishes them as part of a website hosted by server 110. Indexing may be accomplished, according to embodiments, based on the tags associated with a given website with syndication feed listing 302 and for the taxonomy-like hierarchical organization of goods and services of commercial entries according to embodiments. According to other embodiments, keywords may be selected from a listing's description and used for the purposes of indexing. At the time of or after server 110 obtains website with syndication feed listing 302, server 110 may notify the website with syndication feed 300 that the listing has been republished by posting an automated comment or by using trackback feature, according to embodiments. Artisans will understand and know the process of alerting a website with syndication feed 300 that a listing has been republished.

Once indexed, republished listings 200 are searchable. Associated with server 110 may be search engine 150. Those skilled in the art will know and understand how to incorporate search functions into the listing republication system 100 and provide an interface for searchers to search. Searchers may search using keywords. According to embodiments, users may also input geographical data regarding where they are located and receive hierarchical results lists based on geography, as described in detail below.

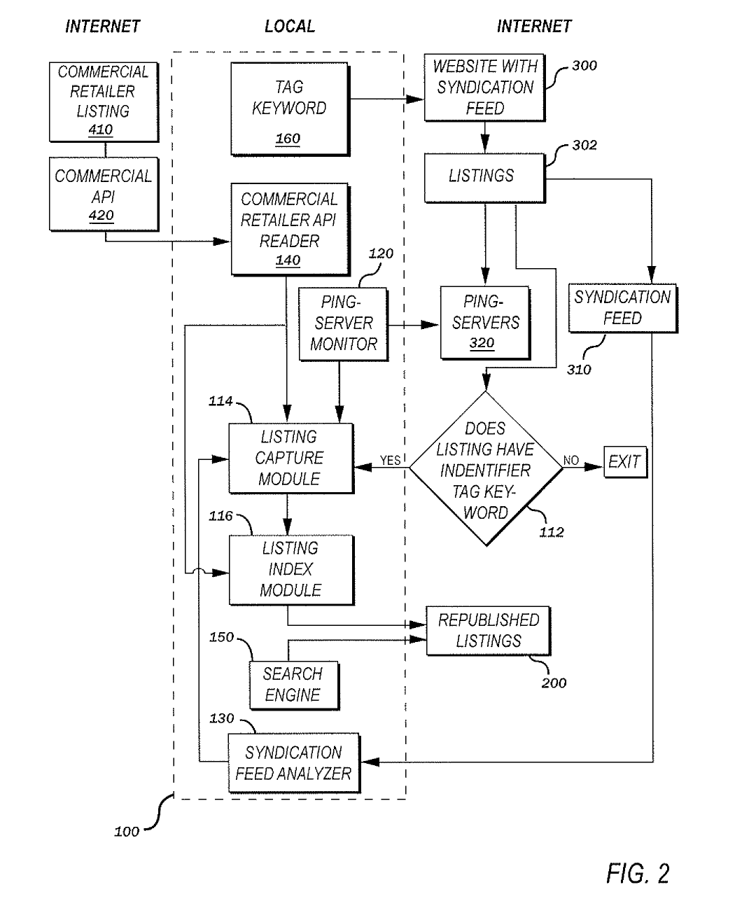

Turning to an embodiment of a method shown in FIG. 2, listing republication system 100 operates by communicating with websites with syndication feeds 300 or commercial retailers. For use with websites with syndication feed 300, listing republication system 100 provides website with syndication feed 300 users with at least one tag keyword 160. Tag keywords 160 are used to identify website with syndication feed listings 302 that are designed to be republished by listing republication system too. For example, the words “listing” or “listings” may be used for English language websites with syndication feed 300. Users who wish to sell an item or service will include “listing” or “listings” as one of the tags associated with their listings 302. According to embodiments, users are encouraged to include other tags as well, including tags identifying geographical references, such as zip codes or city and state names.

Other words may be used instead of or in addition to “listing” or “listings” according to embodiments. Moreover, equivalent words in languages other than English should be considered to fall within the rubric of the particular English words. Persons of ordinary skill in the art will recognize that the choice of tag keyword 160 is merely an arbitrary identifier that notifies listing republication system 100 to republish a given listing 302.

Once a listing is completed and posted, website with syndication feed 300 must be configured to notify ping-servers 320 of new listing 302 to website with syndication feed 300 for listing republication system 100 to republish new listing 302. Once ping-servers 320 receive notification from website with syndication feed 300 of new listing 302, listing republication system 100 will automatically initiate republication of new listing 302. Ping-server monitor 120 causes listing republication system 100 to visit each website with syndication feed 300 that ping-servers 320 identify as having new listings 302. If one of the tags of each listing 302 is tag keyword 160, then the listing capture module 114 captures the listing for republication 112.

The operation of listing capture module 114 may comprise downloading relevant listing 302, portions of relevant listing 302, indexing relevant listing 302 only together with a globally unique identifier (GUID), or combinations thereof. Artisans will know and understand how to implement listing capture module 114. If listing 302 does not have tag keyword 160, then listing 302 is ignored. The operation of ping-server monitor 120 will be known and understood by a person of ordinary skill in the art, including the method by which ping-server monitor 120 identifies and evaluates listing's 302 tags.

After listing 302 is identified as one having tag keyword 160 and captured via listing capture module 114, listing 302 is indexed by listing index module 116. Indexing of listing 302 may be accomplished as previously described, including by tag or keywords taken from listing's 302 text, according to embodiments. Artisans will recognize indexing is the process by which search engine 140 is enabled to search the listings 302. Effectively, users will include geographic designations in the tags or will provide geographic designations in their user profiles to identify where listing 302 originates. According to embodiments, during the indexing process republished listings 200 may have an expiry tag embedded in republished listing 200 that tells listing republication system 100 when to expire and no longer display republished listing 200

Expiry may be accomplished on the server side by removing the republished listing according to information stored in the expiry tag. Similarly, according to embodiments, expiry may be accomplished by the original listing with a dedicated tag indicating the listing is completed (e.g., adding the tag “completed” to the listing) and notifying the ping server or updating the syndication feed. Similarly, according to embodiments, the listing may simply be removed from the website with syndication feed. When syndication feed analyzer 130 fails to detect the listing in the syndication feed, it will cause the republished listing 200 to be expired.

According to embodiments, listings may be either listed as completed, in which they continue to be republished and are still searchable, and expired, in which the listings are no longer republished or searchable.

If a user changes listing 302 on website with syndication feed 300 and website with syndication feed 300 has syndication feed 330, then syndication feed analyzer 130 may detect the change to listing 302 as communicated in syndication feed 330. As previously described, syndication feed 330 may contain data that indicates time and date of the most recent changes to listing 302. Syndication feed analyzer 130 may therefore periodically monitor syndication feed 330 for changes to listing 302. When a change to listing 302 is observed, listing capture module 114 recaptures listing 302 for re-republication.

For commercial retailers, the process is slightly different where commercial retailers do not tag commercial retailer listings 410. Indeed, many commercial retailers do not use tags at all. Instead, the commercial retailer creates commercial API 420 to describe and navigate the many products they sell. Commercial API 420 often comprises tag-like features in the form of taxonomy-like hierarchical organizations of goods and services. For example, they comprise a category such as “consumer electronics.” Within the “consumer electronics” category, subcategories further describe the products, such as “televisions,” “digital cameras,” “DVD players,” and others. Further subclassification groups products into manageable groupings from a user's standpoint. Many commercial retailer's API's have multiple classification systems, such as by category, by brand name, by price, etc. These classification systems may be used in lieu of tagging systems as indexable and searchable criteria as if they were actually tags, according to embodiments.

According to embodiments, Commercial API 420 may be mapped using a mapping module. Mapping module creates actual tags to then associate with each republished listing 200 republished from the commercial retailer listings 410. Resultantly, each republished listing 200 will comprise the exact data irrespective of the source.

Commercial retailer API reader 140 may be included in embodiments of listing republication system 100 to handle untagged commercial retailer listings 410 as shown by the embodiment in FIG. 2. Those skilled in the art will recognize that the implementation of commercial retailer API reader 140 will vary from commercial retailer to commercial retailer to handle each retailer's specific commercial API 420. Moreover, the implementation of such commercial retailer API reader 140 will be understood by a person of ordinary skill in the art without undue experimentation.

Depending on the embodiment, commercial retailer API reader 140 causes listing capture module 114 to capture each commercial retailer listing 410 and republish each commercial retailer listing 410.

Republished listings 200 are visible to users of the internet. Republished listings 200 may be searched using search engine 140, as previously described. Search terms for republished listings 200 that originate from websites with syndication feed 300 will be the tags and taxonomy-like hierarchical organization “tags” for commercial retailers, according to embodiments. Thus, the better and more descriptive that each user tags a particular website with syndication feed listing 302 or commercial retailer listing 410, the more likely search engine 140 will be to locate and list the republished listings 200 in a list of results. According to other embodiments, listing republication system 100 may parse and index the text associated with each website with syndication feed listing 302.

When search engine 140 is used to search commercial retailer listing 410, the search terms will correlate to the taxonomy categories associated with each commercial retailer listing 410, according to embodiments. However, similar to operation with website with syndication feed listings 302 and according to other embodiments, the descriptive text of commercial retailer listings 410 may be parsed and indexed as searchable terms associated with each republished listing 200 alone or in addition to the taxonomy listings.

A feature that may be associated with commercial retailer listings 410, according to embodiments, allows users using search engine 140 to connect directly with a commercial retailer's website, rather than view lists of republished listings. According to these types of embodiments, once commercial retailer API reader 140 reads a commercial retailer listing 410 via commercial retailer API reader 140, listing republication system 100 intentionally skips listing capture module 114, as shown in FIG. 2. Instead, the data is sent directly to listing index module 116 and each commercial retailer listing 410 is indexed the same as if commercial retailer listing 410 were recaptured. Artisans will readily recognize the ability of implementers to either recapture and index, or simply index commercial retailer listings 410 from commercial retailer to commercial retailer depending on the specific agreement and financial considerations of each partnership.

Searchers searching the indexed, but non-captured, commercial retailer listings 410 with search engine 140 have results provided as if commercial retailer listings 410 were republished listings 200. As users select non-republished commercial retailer listings 410, search engine 150 passes the request and loads the webpage of the commercial retailer containing commercial retailer listing 410. Listing republication system will track these clicks via a GUID or URL for each non-republished commercial retailer listing 410. Use of GUID or URL identifier allows listing republication system 100 to generate revenue for these clicks or eventual purchases based on commercial retailer's affiliate programs, specific agreements, or other revenue generation methods known by persons of ordinary skill in the art.

When a GUID is not provided, the URL of retailer listing 410 may be used instead. In cases where GUID is provided, listing republication system 100 will automatically monitor both and update one or the other in the event of changes to either the URL or GUID, according to embodiments.

Additionally, use of commercial retailers GUIDs or URLs for each commercial retailer listing 410 may be used to monitor and update republished listings 200, according to embodiments. Many commercial retailers do not use syndication feeds to provide updates for commercial retailer listings 410, which can present problems from the standpoint of updating individual listings without crawling the entire commercial website to relocate modified listings. However, using a GUID or URL, listing republication system may periodically revisit each commercial retailer listing 410 individually to periodically update republished listings 200.

According to similar embodiments, small widgets may be created using GUIDs that allow users to insert a small script, such a java script, into their own websites or websites of friends showing the republished listings 200 of interest. Thus, users who click on these links will either pass through listing republication system 100, pause momentarily on a webpage of listing republication system 100, or have a frame of republished listing 200, whether originating from commercial retailer or website with syndication feed 300 opened inside a framework of frames of listing republication website 100, according to embodiments. Artisan will know and understand the alternatives for implementing pass through requests, as is well known in the art. Alternately, users may simply republish the listings on their websites rather than including a widget script to do the same, according to embodiments.

Similarly, according to an embodiment, users may use end-user really simple syndication (RSS) reader software to read listings or monitor listings. Users may list the relevant syndication feed information into their end-user RSS reader, as would be known to persons of ordinary skill in the art.

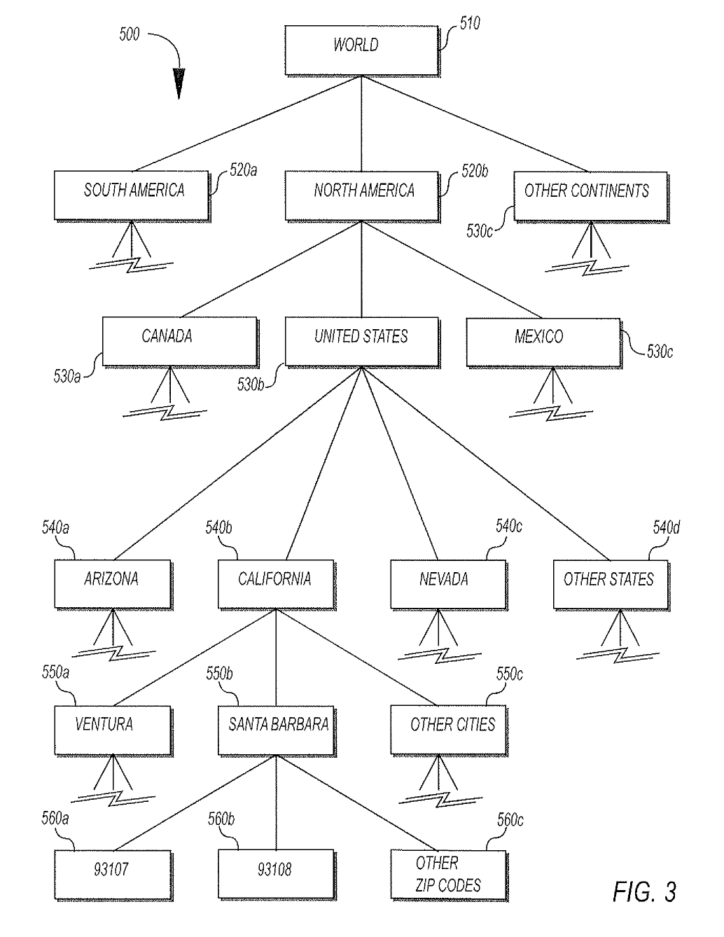

The present disclosure also provides a novel geographical identification system 500 that may be used in conjunction with search engine 140. According to an embodiment of geographical identification system 500 in FIG. 3, an example of a geographic hierarchy from a whole world view, to continent, to country, to state, to city, and finally to zip code is shown. Artisans will recognize the terminology will vary country to country, as well as the implementations of each tier. Indeed, other geographical descriptors may be used with or in place of one or more of the tiers of FIG. 3, including region or county. The geographical identification system 500 includes the ability to provide translations for each location and allows for multiple spellings and versions of each location name, which is then converted into a standardized version of the name used by geographical identification system 500. Artisan will known and understand how to implement these features as part of geographical identification system 500.

An exemplary hierarchy is shown in FIG. 3. At the highest level is world 510. The hierarchy then divides into continents 520a, 520b, and 520c. The next more specific level corresponds to countries. For example, North America 520b may break down into Canada 530a, United States 530b, and Mexico 530c. More specific than country are regional designations within a country, such as states or provinces. United States 540b may break down in Arizona 540a, California 540b, Nevada 540c, and other states 540d. Geographical references in the exemplary embodiment may include counties or cities. For example, cities of California may form the next more specific subset of geographical locations such as Ventura 550a, Santa Barbara 550b, and other cities 550c. Further breakdown may be based on zip code. Santa Barbara 550b may comprise zip codes 93107 560a, 93108 560b, and other Santa Barbara zip codes 560c.

Moreover, artisans will appreciate that the hierarchies presented herein are merely a representation of an organizing principle. More or less detail within the hierarchy is contemplated, as are additional categories. For example, at latitude and longitude system may implemented, wherein each placeholder of in the number indicating latitude and the number indicating longitude represent a hierarchy. For example, a latitude and longitude may be 34.425804°W 119.714189°N. The most general hierarchical level in the latitude would correspond to the 3, the next more specific by 4, etc., according to an embodiment. Naturally other coordinate systems, such at universal transverse Mercator (UTM), are equally applicable, as well as an number of organizations for describing geography from general to specific.

Geographical identification system 500 differentiates between similar names using a weight system. For example, if a listing is tagged as “London,” ambiguity exists as to whether London, United Kingdom is intended or London, Canada. Geographical identification system 500, resolves the locale to include based on a predetermined priority system. Therefore, according to embodiments, London, United Kingdom may have greater priority based on size or population corresponding to the higher likelihood of the listing coming from the more populous or bigger city. According to similar embodiments, priority resolution may be based on IP address, user location, or other indicators suggestive of a particular location in which a listing is based.

When users register for listing republication system 100, they will have the option to provide a home location. Alternatively, or in addition to a registration process, users may tag website with syndication feed listings 302 with a zip code or city, for example. Geographic tags are compared to a geographic hierarchy, for example as shown in FIG. 3. When a match to a known geographic location is made, additional index information is inferred for all locations in the geographic hierarchy more general than the location selected. For example, if a user includes a tag of “Santa Barbara,” geographic identification system 500 would automatically include indexing information corresponding to Santa Barbara 550b, California 540b, United States 530b, North America 520b, and World 510. According to embodiments, Santa Barbara zip code information 560a, 560b, 560c, would not be included, as these locations could not be provided with accuracy. According to other embodiments, however, all or part of Santa Barbara zip code information 560a, 560b, 560c would be inferred and indexed.

Likewise, if a user tagged a website with syndication feed listing 302 with a specific zip code, listing republication system 100 indexes nearby zip codes in addition to the zip code specified, according to embodiments. The nearby zip code information is also indexed with republished listing 200 to allow for search engine 150 to provide results for nearby locations that are not exactly specified by the search but close enough to be reasonably included in the results set. According to similar embodiments, geographical data may be extracted from IP addresses, as is known in the art.

For example, a user may search for a rare item in Ventura, Calif. Naturally, search results would be provided for all rare items that are indexed with Ventura, Calif. index information 550a or associated Ventura zip codes. However, because it is a rare item, search results may come up empty or only with a small number of hits. Consequently, listing republication system 100 may also provide results in nearby communities such as Santa Barbara 550b. To accomplish result list expansion, according to embodiments, listing republication system 100 search engine 150 may use geographical identification system 500 to find nearby communities and thereby expand the search by locality. Search expansion may be accomplished by using zip codes, for example, to locate nearby communities. Similarly, according to embodiments, in event where the geographical hierarchy is sufficiently detailed, search engine 150 may use a classification hierarchy at progressively more general levels to locate similar items.

For example, a user search for a rare item in Santa Barbara by zip code 93107 560a. According to the exemplary embodiment, search engine 150 may not locate any results in 93107 560a. If nearby zip codes are not indexed with each republished listing 200 or that results are not located in nearby zip codes, search engine 150 may automatically move to a more general geographical hierarchical level to expand the search to provide relevant results. According to the example, search engine 150 may search in Santa Barbara 550b when searches under 93107 560a produce no results. All Santa Barbara 550b may, therefore, be searched. Similarly, if results are not located in Santa Barbara 550b, search engine 150 may expand the search again to a more general level, for example, California 540b, and so forth until either a list of relevant search results are produced or search engine 150 determines that no relevant search results exist. Unlike a radius-based system, search engine 150 isn't limited in terms of search results, but will provide a relevant results listings as near to the specified location as possible.

According to embodiments, users may specify in the search a radius in which to search, which will provide a maximum geographical hierarchical level that will be searched by search engine 150 for relevant results. Persons of ordinary skill in the art will know and understand the variations of such a system that are encompassed by the previous disclosure, as well as the ways in which to implement the same.

According to embodiments, a graphical slider may be included in search engine 150 corresponding to a given geographical hierarchy. For example, as shown in FIG. 3, if a user indicates that their zip code is 93108 560b, then the slider will, at one end, have 93108 560b and at the other have world 510. In between will be Santa Barbara 550b, California 540b, United States 530b, and North America 520b. Using the slider, a searcher may obtain a list of all search results at a given geographical level. The slider may then be manipulated to expand or narrow the search by geography. If the user is looking at results for all of California 540b, the searcher may slide the slider towards Santa Barbara 550b to obtain a more local set of results and visa versa. According to embodiments, search bar levels may contain both results for the exactly specified location, e.g., Santa Barbara 550b, as well as nearby locations, such as Ventura 550a. Nevertheless, implementers may impose a cut off at a given geographic level. For example, when the slider is on Santa Barbara 550b, results from Ventura 550a may be provided as well; yet when the slider is on California 540b, results for nearby states would not be included. According to similar embodiments, the presence of and number of nearby localities displays at a given geographical hierarchical level will depend on the number of hits in a given search. Persons of ordinary skill in the art will know and appreciate the principles provided and implement search engine accordingly.

Allowing searchers to dictate the geographical locale provides searchers with the ability to produce search engine results at a desired geographical region. This functionality provides searchers with tools to find results that minimize shipping costs and transit times. Moreover, specifically directed geographical searching provides for in person contact and pickup of internet-initiated transactions. These considerations are especially relevant for items or services that would otherwise carry cost prohibitive shipping fees and transit times. Cars or large devices, such as appliances, typically have narrow resale channels on the internet due to externalities that make online transactions undesired, such as expensive shipping fees and the inability to inspect the products prior to purchase. Thus, the present system provides a platform that allows searchers to specify geographic considerations and overcome many of the externalities that make certain internet-initiated transactions undesirable.

According to embodiments of the present disclosure, business methods are disclosed for maximizing revenues from use of searching systems. According to an embodiment, republished listings 200 may be offered at variable prices. Listing republication system 100 may be provided at no cost to particular classes of sellers. Consequently, these sellers may list sellable items in website with syndication feed 300, include tag keyword 160, and listing republication system 100 will republish their listing 302, index it, and make it searchable.

However, other sellers may be required to pay a commission for republication of their listings. Similarly, sellers having commercial APT's 420 may pay a commission on a per click basis or a per action basis, as is known and understood by a person of ordinary skill in the art. According to similar embodiments, sellers may simply pay a monthly fee to cover all republication of listings 302 or commercial retailer listings 410.

According to embodiments, search results may be preferentially organized according to paid republished listings 200 versus free republished listings 200. According to embodiments, however, users who use listing republication system 100 at no cost will be at a significant disadvantage in terms of having common items located in search results. These users may have more visibility, however, if search engine 150 allows search sorting and they price their goods below the market, according to embodiments. Alternatively, they may desire to pay a fee to increase the visibility of their republished listings 200. The fee the user pays, according to embodiments, will influence the relative placement in search results.

In various embodiments, the listing republication system is operational in an IT infrastructure or with numerous other general purpose or special purpose computing system environments or configurations or other complex systems. Examples of well known computing systems, environments, or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The listing republication system may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit through a network or I/O bus.

In one aspect, the listing republication system includes at least one central processing unit (CPU) or processor. The CPU or processor can be coupled to a memory, ROM, or computer readable media containing the computer-executable instructions for generating and using fingerprints for integrity management. Computer readable media can be any available media that can be accessed by the system and includes both volatile and nonvolatile media, removable and non-removable media implemented in any method or technology for storage of information such as computer readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the listing republication system. Communication media typically embodies computer readable instructions, data structures, program modules, or other data in a modulated data signal such as a carrier wave or other transport mechanism and includes any information delivery media. By way of example, and not limitation, communication media includes wired media such as a wired network or direct-wired connection, and wireless media such as acoustic, RF, infrared, and other wireless media. Combinations of any of the above should also be included within the scope of computer readable media. The computer readable media may store instructions or data which implement all or part of the system described herein.

While the apparatus and method have been described in terms of what are presently considered the most practical and effective embodiments, it is to be understood that the disclosure need not be limited to the disclosed embodiments. It is intended to cover various modifications and similar arrangements included within the spirit and scope of the claims, the scope of which should be accorded the broadest interpretation to encompass all such modifications and similar structures. The present disclosure includes all embodiments of the following claims.

1. A system comprising:
a ping-server monitor to monitor listings from websites with syndication feeds;
a syndication feed analyzer for monitoring syndication feeds of the listings from the websites with syndication feeds;
a unit to detect the presence of at least one tag keyword in the listings; and
a unit to store at least one listing having the at least one tag keyword and make available the listing for republication.

2. The system of claim 1, wherein when the syndication feed analyzer or the ping-server observes a modification to the listing, the system republishes the listing with the modification.

3. The system of claim 2, wherein the at least one listing having the at least one tag keyword is republished by the system.

4. The system of claim 3, wherein the system indexes elements of each republished listing for searching by a search engine.

5. The system of claim 4, wherein the elements are at least one listing tag, at least one listing text element, or combinations of the listing tags and the listing text.

6. The system of claim 5, wherein the tags are syndication feed tags or application programming interface (API) organization descriptors.

7. A method comprising:
providing a tag keyword;
providing a ping-server monitoring unit to monitor at least one ping-server for listings having at least one tag keyword; and
providing a republication unit to republish the listings having the at least one tag keyword as republished listings.

8. The method of claim 7, further comprising:
providing a syndication feed analyzer to periodically analyze the syndication feeds of the listings for modifications;
wherein when the syndication feed analyzer observes a modification to the listing, the republished listing is updated to reflect the modification to the listing.

9. The method of claim 7, wherein the tag keyword comprises at least one of:
listing and listings.

10. The method Of claim 7, further comprising:
providing an application programming interface (API) reader to interact with a system having both an API and listings to retrieve listings for republication.

11. The method of claim 7, further comprising:
providing an indexing unit to index the listings by at least one listing tag, at least one listing text element, or combinations of the listing tags and the listing text elements.

12. The method of claim ii, further comprising providing a search tool to search the republished listings.

13. The method of claim 7, further comprising:
providing a notification unit to notify an originator of the republication of the listing.

14. A machine-readable medium having program instructions stored thereon executable by a processing unit for performing the steps of:
monitoring at least one ping-server for listings having at least one tag keyword; and
republishing the listings having at least one tag keyword as republished listings.

15. The machine-readable medium of claim 14, further comprising:
periodically analyzing the syndication feeds of the listings for modifications;
wherein when the syndication feed analyzer observes a modification to the listing, the republished listing is updated to reflect the modification to the listing.

16. The machine-readable medium of claim 14, wherein the at least one tag keyword comprises at least one of: listing and listings.

17. The machine-readable medium of claim 14, further comprising:
interacting with a system having both an API and listings to retrieve listings for republication.

18. The machine-readable medium of claim 14, further comprising:
indexing the listings by at least one listing tag, at least one listing text element, or combinations of the listing tags and the listing text elements.

19. The machine-readable medium of claim 18, further comprising:
searching the republished listings.

20. The machine-readable medium of claim 14, further comprising:
notifying an originator of the republication of the listing.
